(19) United States
(12) Patent Application Publication
(10) Pub. No.: US 2019/0333334 A1
(43) Pub. Date: Oct. 31, 2019

(54) FIFO Game Enhancement Queue

(71) Applicant: Bally Gaming, Inc., Las Vegas, NV (US)

(72) Inventor: Joel Roger JAFFE, Glenview, IL (US)

(21) Appl. No.: 15/967,088

(22) Filed: Apr. 30, 2018

(51) Int. Cl. G07F 17/32; G07F 17/34

(52) U.S. Cl. CPC G07F 17/3267; G07F 17/34; G07F 17/3227; G07F 17/3213

(57) ABSTRACT

A gaming system includes a first-in-first-out (FIFO) queue data structure that functions to construct distinctive combinations of game enhancements for application to successive game instances.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2018, Bally Gaming, Inc.

### FIELD OF THE INVENTION

The present invention relates generally to gaming systems, apparatus, and methods and, more particularly, to a gaming system in which game-logic circuitry executes instructions that employ a particular data structure to produce combinations of distinct pluralities of symbols, discrete paytables, and other elements to generate distinct and innovative game compositions for successive game instances.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

Additionally, players require frequent variation—preferring a steady diet of new and innovative games that provide different challenges and suggest unique strategic approaches to game play—which at least partly explains the huge variety of different gaming machines one finds in a casino. But casino floor space is limited (and therefor expensive) and new game development can be a lengthy process. In the past, game manufacturers have experimented with multi-game machines that are equipped with several complete and distinct game programs that available for selection by the player. Even so, the cost of memory storage sufficient to hold all the art and imager assets of multiple games cannot be ignored, and multiple games still require multiple development efforts—packing them into a single cabinet doesn't reduce the programming etc. necessary to produce a new electronic wagering game. It would be a great benefit to introduce a gaming system which automatically creates a new wagering game structure for each successive game instance.

One way game manufacturers in the past tried to lasso players' interest over time was to augment their base (or basic) games with exciting bonus games that could be triggered periodically during play of the base game. The bonus games would provide significantly higher payouts and include exhilarating features—free spins, picking games, video clips and sound effects—that went far beyond the features of the base games. However, seasoned players would quickly become familiar with the structure of the bonus games in the same way as they became tired of the base games. In both arenas—in both base games and bonus games—players sought new and unexpected structures, configurations, and features.

It would be advantageous to design a game—bonus game or base game—in which each spin initiates a unique (or nearly unique) variation on a theme, so that players are provided with a different composition of paylines, bonus awards, game symbols, and/or winning combinations with each spin or each time they initiate a game instance. Each instance would be, in effect, a new and different game with constantly changing mechanics.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

As the industry matures, the creativity and ingenuity required to improve such operations of gaming apparatus and games grows accordingly.

### SUMMARY OF THE INVENTION

According to one aspect of the present invention, a gaming system configured to present successive, enhanced symbol arrays over successive game instances includes one or more electronic display devices and game-logic circuitry configured to present a symbol array by directing at least one of the one or more electronic display devices to display a First-In-First-Out (FIFO) queue having an entry position, an exit position, and one or more intermediate positions between the entry and exit positions. The game-logic circuitry further selects a game enhancement from a plurality of available game enhancements, each game enhancement being associated with a respective enhancement identifier, and directs at least one of the one or more electronic display devices to shift any enhancement identifiers in the FIFO queue from the entry position towards the exit position. The game-logic circuitry directs at least one of the one or more electronic display devices to display the enhancement identifier for the selected game enhancement entering the FIFO queue at the entry position and any enhancement identifier at the exit position leaving the FIFO queue. The game-logic circuitry randomly generates a game outcome and applies all game enhancements having enhancement identifiers in the FIFO queue to the game outcome, and directs at least one of the one or more electronic display devices to display the symbol array representing the game outcome. The game-logic circuitry is further configured to present subsequent symbol arrays by repeating the selecting, shifting, and randomly generating steps.

According to another aspect of the invention, a game enhancement queuing method for a gaming system including game-logic circuitry includes the game-logic circuitry directing one or more electronic display devices to display a First-In-First-Out (FIFO) queue having an entry position, an exit position, and one or more intermediate positions between the entry and exit positions, and selecting a game enhancement from a plurality of available game enhancements, each of the plurality being associated with a respective enhancement identifier. The game-logic circuitry further directs one or more electronic display devices to shift any enhancement identifiers in the FIFO queue from the entry position towards the exit position with the enhancement identifier associated with the selected game enhancement entering the FIFO queue at the entry position and any enhancement identifier at the exit position leaving the FIFO queue. The game-logic circuitry randomly generates a game outcome and applies all the game enhancements associated with enhancement identifiers in the FIFO queue to the game outcome. Also, the game-logic circuitry directs one or more electronic display devices to display a symbol array representing the game outcome with the applied game enhancements, and repeats the directing, selecting, and randomly generating steps to present one or more subsequent symbol arrays.

According to a further aspect of the invention, a game enhancement queuing method for a game sequence includes providing, via game-logic circuitry, a data structure establishing a logical First-In-First-Out (FIFO) queue having an entry position, an exit position, and one or more intermediate positions between the entry and exit positions, and displaying, on at least one electronic display device via direction of the game-logic circuitry, a visual representation of the logical FIFO queue including one or more game enhancement identifiers, each of the one or more enhancement identifiers being associated with a respective game enhancement assigned to a particular logical FIFO queue position. The method includes selecting, via game-logic circuitry, a game enhancement from a plurality of available game enhancements and assigning the selected game enhancement to the entry position of the logical FIFO queue, any game enhancements in the logical FIFO shifting from the entry position towards the exit position. The method further includes shifting, on an electronic display device via direction of the game-logic circuitry, any enhancement identifiers in the displayed FIFO queue from the entry position towards the exit position with the enhancement identifier for the selected game enhancement entering the displayed FIFO queue at the entry position and any enhancement identifier at the exit position leaving the displayed FIFO queue. The method randomly generates a game outcome and applies all game enhancements assigned to positions in the logical FIFO queue to the game outcome and displays, on at least one electronic display device via direction of the game-logic circuitry, a symbol array representing the game outcome with the applied game enhancements. The method repeats the selecting, shifting, and randomly generating steps to present a subsequent symbol array.

According to yet another aspect of the invention, a gaming system configured to present distinctive, successive, enhanced symbol games over successive game instances includes one or more electronic display devices and game-logic circuitry configured to present a symbol array by directing at least one of the one or more electronic display devices to display a parade route populated by a procession of game enhancement icons, each enhancement icon having game enhancement identifier a corresponding with one of a plurality of available game enhancements. The game-logic circuitry is configured to randomly select a game enhancement from the plurality and, in response to selecting the game enhancement, direct one of the one or more electronic display devices to divert one the procession of enhancement icons from the parade route to a reception area, the diverted one having the enhancement identifier corresponding to the selected game enhancement. The game-logic circuitry is further configured to direct at least one of the one or more electronic display devices to display the enhancement identifier corresponding to the selected game enhancement at an entry position of a First-In-First-Out (FIFO) queue and to shift any other game enhancements in the FIFO queue towards an exit position, and to direct at least one of the one or more display devices to display the first symbol array with the first game enhancement applied thereto. The game-logic circuitry is further configured to repeat the preceding steps to present subsequent symbol array.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a game displayed on a gaming machine, according to an embodiment of the present invention.

FIG. 4 is a diagram of an exemplary first-in-first-out (FIFO) queue data structure.

FIG. 5 is a flowchart for an algorithm that corresponds to instructions executed by a controller in accord with at least some aspects of the disclosed concepts.

FIG. 6 is an image of an exemplary game screen of a wagering game displayed on a gaming machine, according to an embodiment of the present invention.

FIG. 7 is an image of a parade portion of the game screen shown in FIG. 6.

FIG. 8 is an image of an array portion of the game screen shown in FIG. 6.

FIGS. 9-14 include illustrations of various game enhancement icons and enhancement identifiers, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like may include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

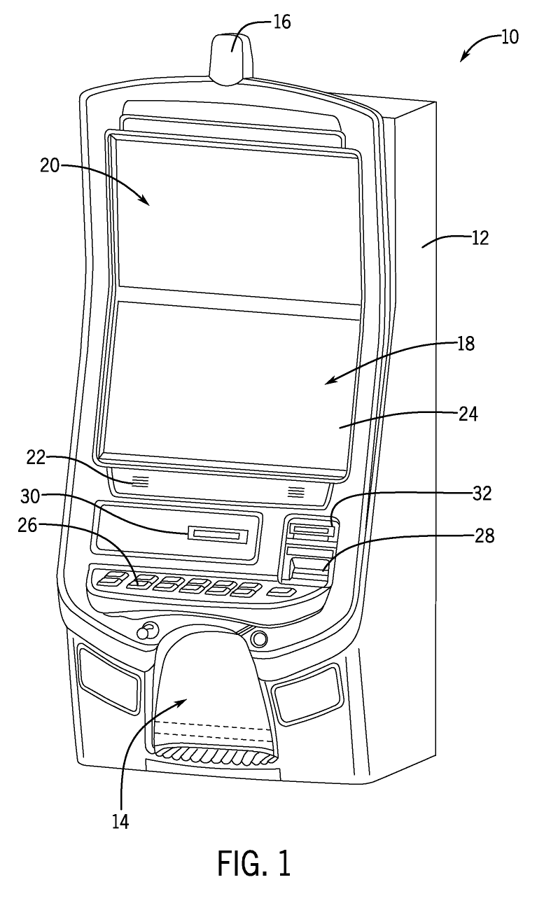

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10. The gaming machine 10 may be used to present non-wagering game as well.

The input devices, output devices, and input/output devices are disposed on, and securely coupled to, the cabinet 12. By way of example, the output devices include a primary display 18, a secondary display 20, and one or more audio speakers 22. The primary display 18 or the secondary display 20 may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 24 mounted over the primary or secondary displays, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

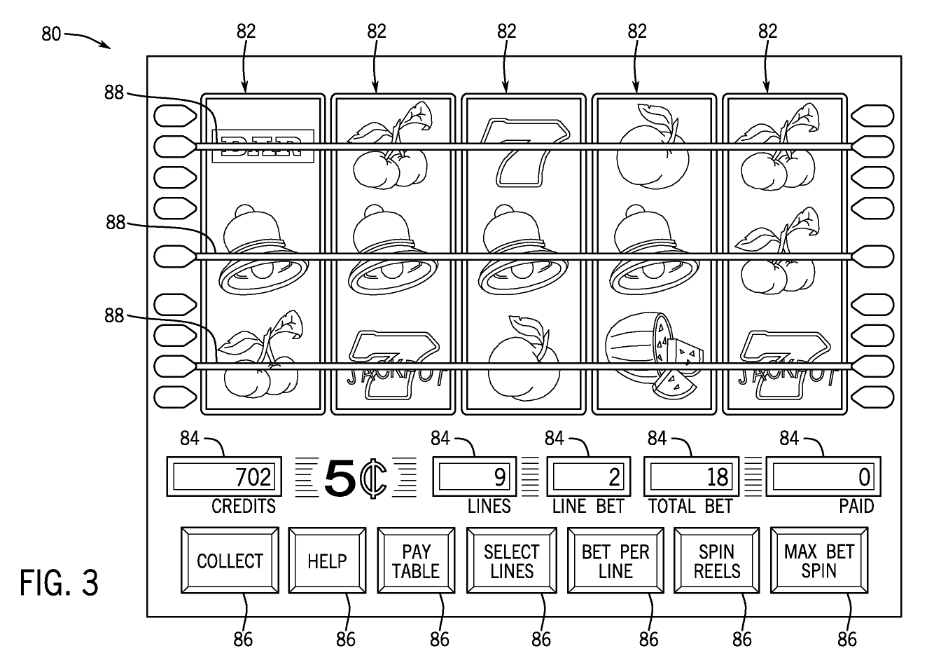

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 84 (see FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 84 (see FIG. 3), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

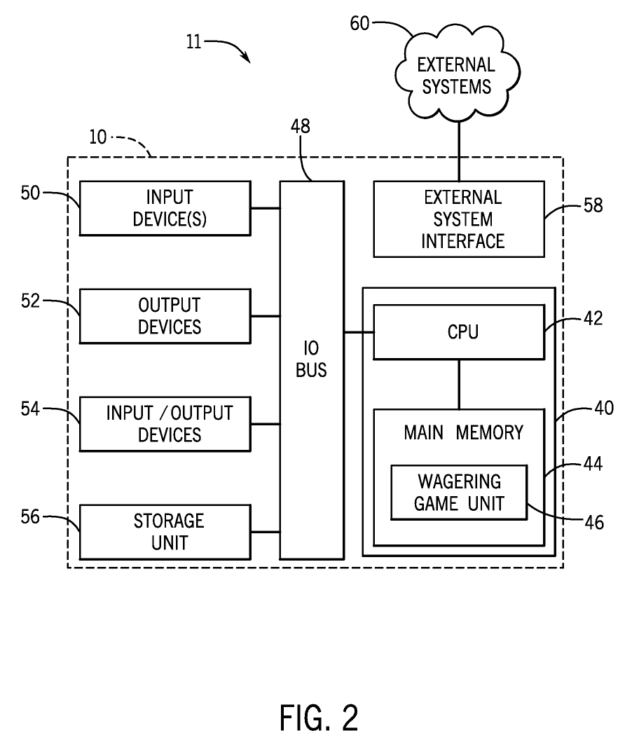

Turning now to FIG. 2, there is shown a block diagram 11 of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager covered by or deducted from the credit balance on the “credits” meter 84, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example).

As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14.

Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

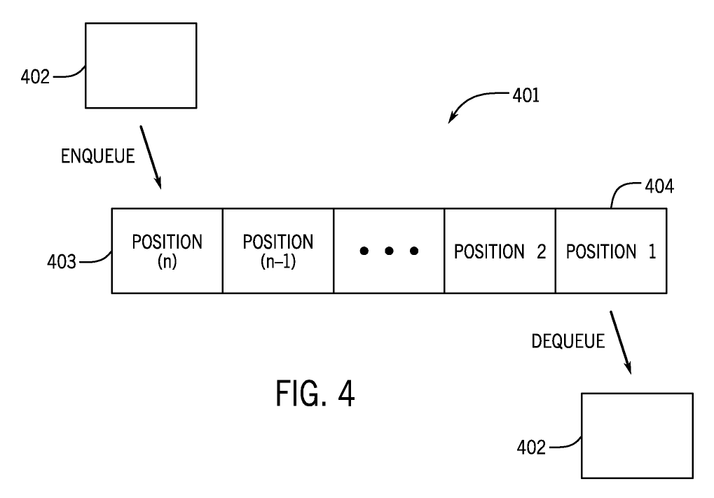

Referring to FIG. 4, there is shown an diagram of an abstract data structure organized as a first-in-first-out (FIFO) queue 401 in which elements of the queue are kept in order of entry. The principal operations on the queue are the addition of entities 402 (enqueuing) to the rear terminal position 403 (referred hereafter as the “entry position”), and removal of entities 402 (dequeuing) from the front terminal position 404 (referred hereafter as the “exit position”). A FIFO queue can be implemented in computer programming in many ways, for example, as a memory buffer, a linked list, database, etc. These and other queue implementations that function as a FIFO queue are common in computer programming and are considered to be well within the aspects of the invention. A FIFO queue functions like a line at the box office or print jobs sent to a printer—each entity enters the queue at one end and moves incrementally towards the other end, after which they leave the queue.

In the current disclosure, reference is made to the computer implementation of the FIFO queue and its various terminal positions, and also to a visually displayed representation of the FIFO queue. In some instances, the different embodiments of the FIFO queue are distinguished by “logical FIFO queue,” referring to the data structure, and by “displayed FIFO queue,” referring to the visual representation. However, since the data structure and the visual representation typically function identically, any reference to a FIFO queue in the current disclosure can be interpreted to mean either the data structure, the visual representation, or both.

The game-logic circuitry executes instructions in order to present a game. In an embodiment of the invention, there is a plurality of instructions related to game play for execution either singly or in combination. Programmed instructions—subsets of the plurality—may be executed to implement respective game enhancements that may be applied to a given game outcome. The invention maintains a FIFO queue of a predetermined number of game enhancements (GEs) for implementation during each spin (e.g., either a base game spin or a bonus spin). The GEs that may be applied include enhancements to the available symbols displayed to represent the game outcome, modifications to the rules applied to interpret combinations of displayed symbols, enhancements/alternatives to paytables that determine awards for winning combinations. For each spin, multiple GEs (e.g., all the enhancements in the FIFO queue) are applied to construct the instant game, and at least one of the enhancements in the FIFO queue is changed for each spin. In effect, the application of the multiple enhancements in the FIFO queue, the combined effects of the multiple enhancements, and the ever-changing permutations resulting from advancing the FIFO queue each spin, add up to the game machine literally presenting different game with each spin.

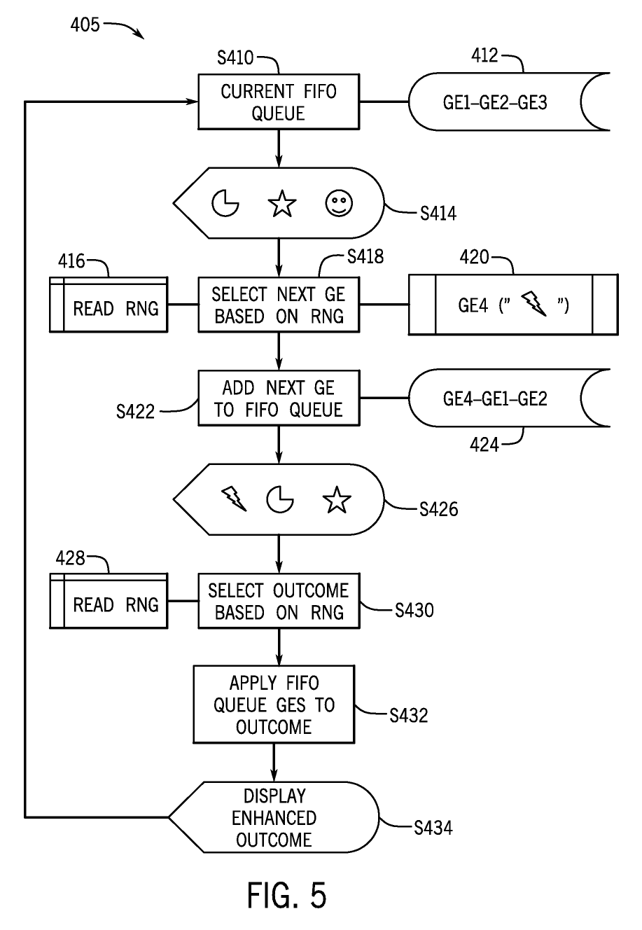

Shown in FIG. 5 is a flowchart 405 depicting exemplary instructions and operations for implementing an embodiment of the invention. In operation of the embodiment, the game-logic circuitry assesses 5410 a FIFO queue 412 that includes a series of GEs selected from a group of available GEs. An exemplary queue may include GE 1, GE 2, and GE 3. The embodiment may display 5414 the game enhancement icons representing the respective GEs on one or more electronic display devices.

The game-logic circuitry may then access the RNG 416 to determine 5418 the next GE (e.g., GE 4) 420 of the plurality of GEs for adding 5422 to the FIFO queue 424. The embodiment may display 5426 the incremented FIFO queue 424.

In the embodiment, the game-logic circuitry refers to the RNG 428 to determine 5430 an outcome for the game and cumulatively applies 5432 all the GEs in the current FIFO queue to the game outcome. Finally, a visual representation of the enhanced game outcome is displayed S434.

FIG. 5, described by way of example above, represents one algorithm that corresponds to at least some instructions stored and executed by the game-logic circuitry 40 in FIG. 2 to perform the above described functions associated with the disclosed concepts.

As described above, game enhancements may affect a game outcome in different ways. Some game enhancements may modify/add to/subtract from the symbols available for displaying to represent the game outcome. For example, a slot game may display an array of mechanical or virtual (video) symbol-bearing reels that are spun and stopped to display a representation of a randomly generated game outcome. The symbols that are visible when the reels stop are evaluated, according to various characteristics including the symbol itself, its position with respect to other displayed symbols, a number of simultaneously displayed like symbols, etc., for occurrences of predetermined symbol combinations.

An embodiment employs a FIFO queue to produce combinations of game enhancements that change with each game instance. In this way, a game is reconfigured anew for a new game instance, and the game enhancements combine in different, sometimes complementary, fashion that can increase a player's anticipation and provide the sense of “near miss” that is thought to create excitement and prolong play of a particular game. One example of “complementary” combination, taken from the examples discussed below, would be a current FIFO queue that includes one or even two game enhancements that add extra Munchkin symbols to the reels of a symbol array. If the next selected game enhancement causes all Munchkins symbols to be WILD, a player's likelihood of a winning symbol combination in the subsequent symbol array increases significantly.

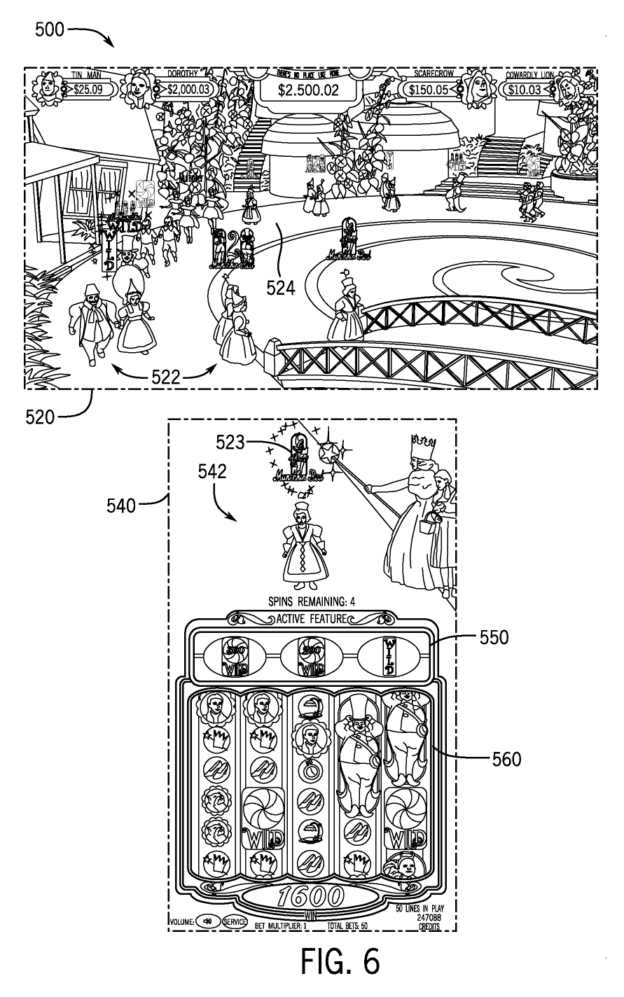

Referring now to FIG. 6, there is illustrated a game screen 500 for an embodiment of the invention. In the embodiment of FIG. 6, the game is a bonus game triggered during a base game. As discussed previously, other embodiments may be structured as a base game and still incorporate inventive aspects considered to be within the scope and intent of this disclosure. The game screen 500 includes a parade 520 and a reel array 540, with the parade 520 exemplifying a game enhancement selection process for populating the FIFO queue and the array 540 presenting varying symbols representing the game outcome enhanced by the GEs in the FIFO queue. The game screen 500 is configured with the parade 520 in landscape view displayed above the array portion 540 in portrait view. Depending on the particular cabinet implemented to present the embodiment, the parade 520 may be displayed on a separate electronic display device from the array 540. Alternatively, both the parade 520 and the array 540 can be displayed on a single display device.

The parade 520 comprises a plurality of game enhancement icons 522 moving along a parade route 524. In the illustrated embodiment, the plurality of game enhancement icons 522 is shown as a procession of Munchkins. The parade route 524 is configured such that icons can proceed around the route continuously (e.g., via a bridge), or a selected icon can detour towards the array 540 to a queue reception area 542 prior to entering the FIFO queue. Of course, the reception area 542 may be eliminated so that icons move directly from the parade route to the FIFO queue. Each icon 522 is associated with a particular game enhancement that is symbolized in a game enhancement identifier 523 proximal to the respective icon 522.

In the embodiment of FIG. 6, the image of the current FIFO queue 550 with the game enhancement identifiers 523 representing the game enhancements in the queue are displayed directly above the symbol-bearing reels 560 in the array 540 and the reception area 542 is displayed directly above the FIFO queue 550.

As the game enhancement icons 522 proceed around the parade route, a game enhancement identifier 523 may appear proximal to (e.g., above) a particular icon to identify the game enhancement that corresponds to the icon. In this way, different game enhancements may be associated with the same icon at different times, reducing the need for storage and processing to generate separate icon images for each game enhancement. The enhancement identifiers may be unseen or indiscernible for some portion of the parade route and/or for some of the icons. For example, the identifiers may appear blurred or grayed at a certain point on the parade route and become distinct as the icon moves to the foreground.

For visual presentation, the enhancement icons may advance around the parade route to provide entertaining imagery and also to generate player anticipation as valuable enhancements approach the foreground and either veer off to enter the reception area or march past to continue in the parade. Enhancements may be selected via various means for entrance into the queue, including selection based at least partly on one or more randomly generated numbers. A new enhancement is selected and inserted in to the FIGO queue prior to each spin.

When a game enhancement is selected to enter the FIFO queue, the game-logic circuitry increments the queue—the enhancement in GE3 is discarded from the queue; the enhancements currently stored in GE1 and GE2 advance to GE2 and GE3, respectively; and the newly selected enhancement is stored in GE1. Thus, the FIFO queue is modified and ready for implementation on the subsequent spin.

As discussed previously, the game-logic circuitry executes stored instructions in order to present each instance (e.g., each spin) of the game. Prior to initiating a spin, the game-logic circuitry assesses the FIFO queue to determine which game enhancements are to be applied to the spin. Since the enhancements in the queue are cumulative (i.e., all enhancements in the queue are applied to a single spin), and further since the queue is modified with each spin by the addition of a new enhancement and the deletion of an old enhancement, each spin effectively executes a unique set of instructions that are prepared specifically to implement the enhancements currently stored in the queue. The assessment step identifies the enhancements in the queue and, via various means, prepares the overall instruction set to be executed. In an embodiment, instructions may be prepared by selecting instruction subsets corresponding to the queued enhancements and incorporating them into the overall instruction set. Alternatively, the queued enhancements may indicate a series of table look-ups in which data is retrieved and utilized to populate elements of the instruction set.

Responsive to one or more of the queued enhancements, the game-logic circuitry may change some or all of the symbols available for representing the game outcome, may change one or more elements of a paytable to reflect higher or lower awards for a symbol combination, may modify the definitions of winning combinations, or combinations thereof.

As discussed previously, the game-logic circuitry may execute programming to operate one or more random number generators (RNG), and numbers generated by RNG may be utilized in determining a game outcome. In an embodiment, a game outcome is determined based on one or more random numbers and the game-logic circuitry executes instructions for displaying a symbol array populated by symbols selected from the plurality of available symbols. The symbol array may represent at least a part of the game outcome by displaying particular symbols and symbol combinations. Further, the instruction set prepared for the current spin may evaluate the symbol array in accordance with the enhancements in the FIFO queue to determine awards, bonuses, and other features resulting from the confluence of the queued enhancements, the game outcome, and other potential influences (e.g., wager amount, player account status, etc.)

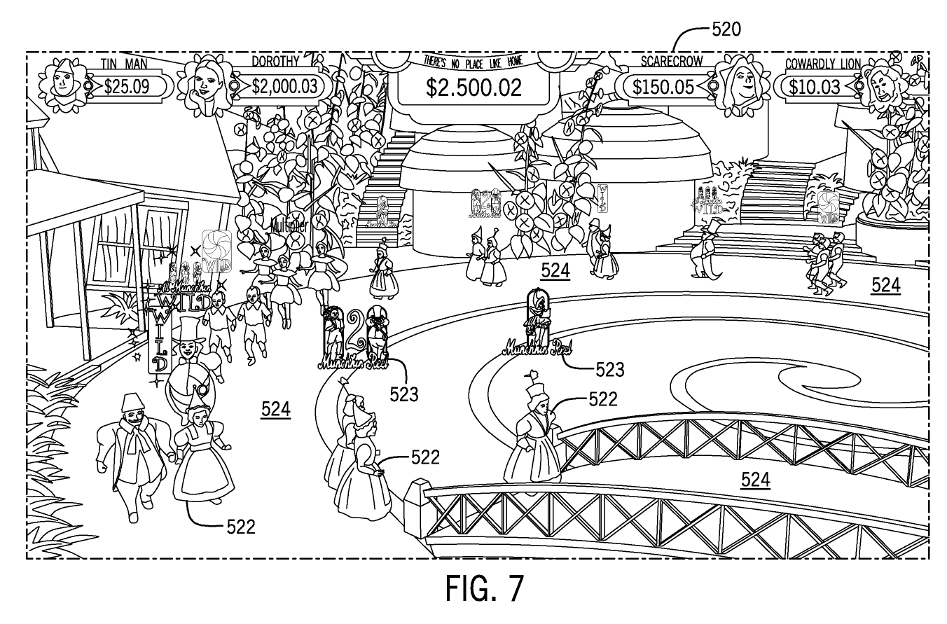

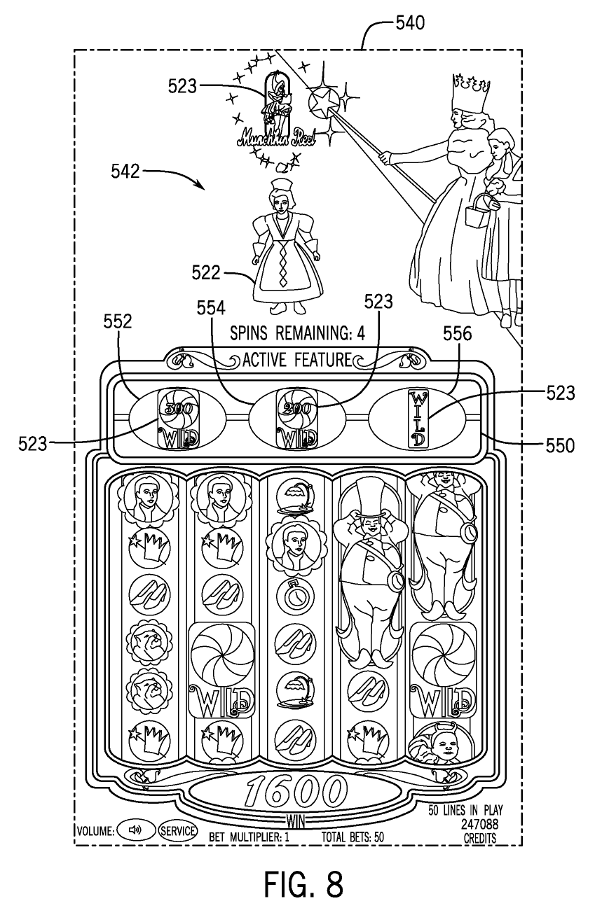

Referring now to FIGS. 7 and 8, there are illustrated detailed images of a parade 520 and an array 540, according to an embodiment of the invention. In FIG. 7, the parade 520 is populated by a procession of enhancement icons 522 on the parade route 524. Enhancement identifiers 523 can be seen hovering above each icon 522, although the details of the identifiers 523 may not become visually discernable until the icon approaches the foreground. And, as the icons 522 approach the foreground they can either turn to proceed along the parade route 524 i.e., over the bridge) or disengage from the parade and proceed to the reception area 542 (in FIG. 8).

As shown in FIG. 8, the array 540 includes an enhancement icon 522 with a corresponding identifier 523 waiting to enter the FIFO queue 550. In this embodiment, the FIFO queue 550 current contains three identifiers 523 representing the game enhancements in the entry position 552, the intermediate position 554, and the exit position 556. According to FIFO queue protocol, the identifier in the reception area 542 will enter the queue at the entry position 552, and the identifiers currently in the entry position 552 and the intermediate position 554 will move to the intermediate position 554 and the exit position 556, respectively. The identifier currently at the exit position 556 will be removed from the queue.

Game play of an embodiment, presented here for example only, may begin with an occurrence of a triggering event in a base game. The trigger event initiates the bonus game and allots an initial number of spins. The bonus game displays the parade with the Munchkin icons marching around the parade route and, below the parade, displays the array. Above each icon there is shown an enhancement identifier associated with a particular game enhancement. Prior to the first spin, the reception area and the FIFO queue maybe empty.

As the icons march along the parade route, one icon (and its respective identifier) veers off the route and enters the reception area, indicating the selection of the game enhancement associated with the identifier. To show the game enhancement entering the FIFO queue, the identifier is displayed in the entry position of the FIFO queue. If the selected game enhancement affects the symbols of the array, the prescribed changes are implemented and the first spin is executed as indicated by spinning the reels of the array. When the reels stop to show the symbols representing the randomly selected game outcome, the game-logic circuitry applies the game enhancement to the outcome and, if warranted, provides an award. This completes the first spin.

For the second (and subsequent spins) the cycle repeats with a second Munchkin icon veering off the parade route and moving to the reception area to indicate the selection of the next game enhancement. The identifier in the entry position shifts to an intermediate position and the identifier of the second icon is displayed in the entry position. With two game enhancements now in the FIFO queue, the second spin is executed to display the symbols representing the second randomly selected game outcome and both the game enhancements in the FIFO queue are applied to the second game outcome. The cycle repeats until all the allotted spins are completed.

The disclosed subject matter lends itself to implementations that improve computer functions by way of reducing RNG pulls, accelerating processing speed by minimizing redundancies and streamlining analysis, and reducing memory requirements.

For example, an embodiment with the persistent FIFO queue equates to only a single RNG call per spin, from the list of available game enhancements, corresponding to the new addition to the FIFO queue. The remaining enhancements in the queue are held over from the previous spin, with the exception of the last element which is bumped from the queue. In comparison, an embodiment which repopulates the entire queue each spin requires either one RNG pull for each queue position or one RNG pull from a list of all possible permutations of the queue positions, which would be a very lengthy list of permutations requiring significant memory resources.

For another example, an embodiment in which the enhancements in the parade repeat during the spins (e.g., there are X different enhancements that parade continuously in the same order) does not require additional RNG pulls to repopulate the line of available enhancements.

Additionally, there are graphics-related memory and processing savings resulting from an embodiment that reuses 3D models of enhancement icons in a continuous loop as opposed to removing them and recreating them in a “use-once-then-discard” scenario.

In general, embodiments utilizing a multi-step selection (e.g., creating a list of enhancement icons, assigning identifiers to the icons, and the selecting from that list to populate the FIFO queue) means the weighted tables associated with the icons, their assigned identifiers, and selections for the FIFO queue, are much smaller (both individually and in total) than a weighted table that pulls everything at once from a giant list of all possible combinations.

The invention disclosed within may be implemented using a variety of images, themes, and styles. One of the many possibilities will be discussed here in detail, without restricting or limiting other embodiments, and other embodiments are considered to be within the scope of the invention.

One embodiment may present the invention according to a fantasy theme. As shown in the embodiment illustrated in FIG. 6, the enhancement icons 522 are characters in gaily colored attire who march around the parade route 524. There is an enhancement identifier 523 hovering overhead of each enhancement icon 522 that identifies the specific game enhancement associated with the respective enhancement icon. As the characters approach the foreground, they either turn suddenly to proceed along the route or march forward to approach the reception area 542—indicating the approaching characters embody the enhancement selected for addition to the FIFO queue. This presentation is both amusing and exciting—the player is able to watch the type of enhancement associated with the approaching character(s) and anticipate the effect the enhancement will have on the subsequent spin. If the character(s) suddenly turns away and continues along the parade route, the player may experience a “near miss” sensation that is known to encourage continued game play. On the other hand, if the character(s) makes their way to the reception area, the player may experience the anticipation of enhanced outcome resulting from the enhancements inclusion in the queue.

As mentioned, FIG. 6 illustrates the imagery utilized in at least one embodiment. Other embodiments may include modified imagery and different themes. For example, the parade route might instead be a race track and the enhancement icons include race cars, horses, or other racing-type images. In another embodiment, enhancement icons may proceed along a path in an urban landscape—the icons may be images of various city-dwellers such as business persons, street vendors, police, bicycle delivery persons, etc. Alternatively, an embodiment could have a circus theme depicting a parade of circus animal and performers. Various other examples of imagery, themes, and combinations thereof can be presented in an embodiment while still remaining within the spirit and aspect of the invention disclosed herein.

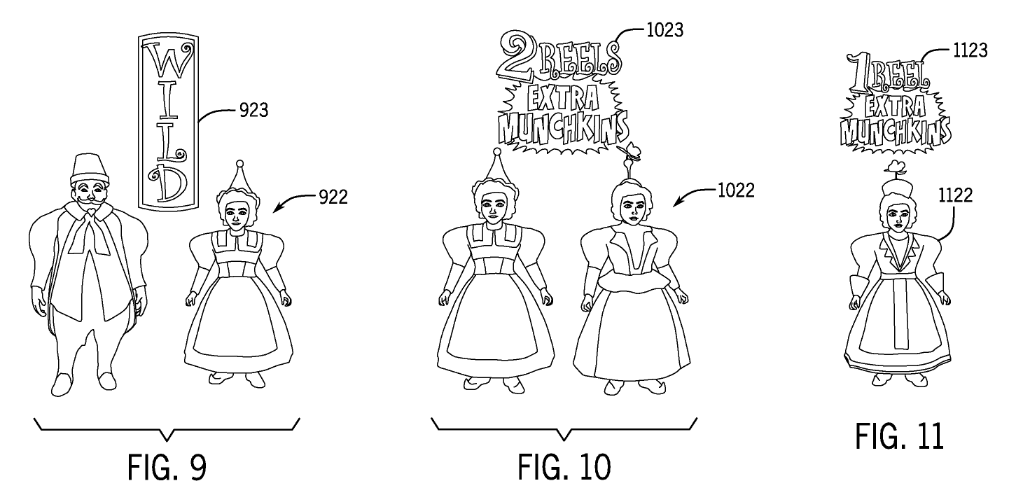

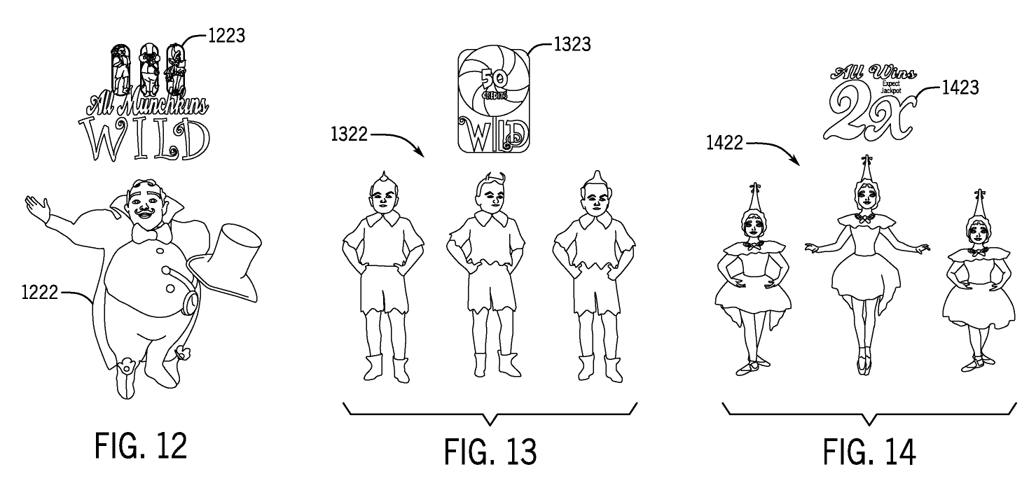

FIGS. 9-14 illustrate some exemplary game enhancement icons and enhancement identifiers. These are presented as examples only, and examples from a particular imagery theme, and are not intended to be limiting in any way. FIG. 9 shows a Munchkin villagers icon 922 with a corresponding “WILD reel” identifier 923 that converts one reel of the array into all WILD symbols. FIG. 10 shows another Munchkin villagers icon 1022 with a corresponding “2 Reels Extra Munchkins” identifier 1023 that adds Munchkin symbols to two reels of the array. Similarly, in FIG. 11, there is shown a Munchkin villager 1122 icon with a corresponding “1 Reel Extra Munchkins” identifier 1123 that adds Munchkin symbols to a reel of the array. In FIG. 12, there is shown a Munchkin Mayor icon 1222 with a corresponding “All Munchkins Wild” identifier 1223 that, when applied to a spin, turns all Munchkin symbols in the array to WILD symbols. FIG. 13 shows a Lollipop Guild icon 1322 with a corresponding “50 Credits Wild” identifier 1323 that adds 50 credit WILD symbols to the array. Also, FIG. 14 shows a Munchkin Lullaby League icon 1422 with a corresponding “All Wins 2×” identifier 1423 that multiplies any win resulting from a spin by two.

An embodiment may utilize different numbers of icons and enhancements (thus, identifiers). In particular, a smaller number of icons may populate the parade with the same icon being associated with more than one game enhancement, or vice versa.

As indicated in this disclosure, and as those knowledgeable with the gaming arts, the enhancements can includes many different types of enhancements and combinations thereof. An embodiment may include a “Toto” enhancement that provides additional free spins to extend a bonus feature. Further, as shown in the abovementioned enhancement identifiers, some enhancements may include sub-attributes that add further variety to the available enhancements. For example, 1 Reel Extra Munchkins and 2 Reel Extra Munchkins can be structured as sub-attributes of a general Extra Munchkins enhancement. Similarly, All Wins 2× could include sub-attributes with different multiplier values, and the WILD reel enhancement could include sub-attributes like 2 Reels and All Reels. Sub-attributes can be assigned by a separate random selection than the general enhancement. These variations, other variations and enhancements, and combinations thereof are considered to be within the scope and aspect of the invention disclosed herein.

The Munchkin parade discussed above is simply one exemplary theme that can be employed in a presentation of the invention, and the abovementioned icons, enhancements, identifiers, and background imagery should not be interpreted as limiting the invention.

For example, an embodiment of the invention may employ a car-racing theme in which a race track is substituted for the parade route. In the car-racing embodiment, the enhancement icons may be represented by different race cars, the enhancement identifiers may be sketched in a racing-themed imagery, the reception area may be represented by a pit-stop, etc. Similarly, an embodiment may have a circus theme, a beauty pageant theme, a political election theme, etc.

While the abovementioned embodiments are focused on a game with symbol-bearing reels, the invention may be easily applied to different types of games. The FIFO queue data structure may be employed as described herein to construct distinctive combinations of game enhancements for a card game, picking game, episodic game, etc. with similar benefits as those described above. These variations and others are considered to be within the scope and aspect of the invention disclosed herein.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system configured to present successive, enhanced symbol arrays over successive game instances, the gaming system comprising:
one or more electronic display devices;
game-logic circuitry configured to present a symbol array by:
directing at least one of the one or more electronic display devices to display a First-In-First-Out (FIFO) queue having at least an entry position and an exit position;
selecting a game enhancement from a plurality of available game enhancements, each game enhancement being associated with a respective enhancement identifier;
directing at least one of the one or more electronic display devices to shift any enhancement identifiers in the FIFO queue from the entry position towards the exit position with the enhancement identifier for the selected game enhancement entering the FIFO queue at the entry position and any enhancement identifier at the exit position leaving the FIFO queue;
randomly generating a game outcome and applying all game enhancements having enhancement identifiers in the FIFO queue to the game outcome;
directing at least one of the one or more electronic display devices to display the symbol array representing the game outcome; and
the game-logic circuitry further configured to present subsequent symbol arrays by repeating the selecting, shifting, and randomly generating steps.

2. The gaming system of claim 1, wherein presenting the symbol array includes successively displaying the enhancement identifiers associated with the plurality of game enhancements during a game instance, and wherein the enhancement identifier associated with the selected game enhancement is visually indicated prior to being displayed at the entry position.

3. The gaming system of claim 1, wherein the game-logic circuitry is further configured to, in response to detecting a wager of a first amount, populate the FIFO queue with enhancement identifiers that were in the FIFO queue after a previous wager of the first amount.

4. The gaming system of claim 1, wherein the game-logic circuitry is further configured to, in response to a trigger event occurring during a game instance, introduce another game enhancement beyond the game enhancements represented by the enhancement identifiers in the FIFO queue.

5. The gaming system of claim 1, wherein one or more of the plurality of game enhancements change the symbols available for a symbol array.

6. The gaming system of claim 1, wherein one or more of the plurality of game enhancements alter a paytable applied to the game outcome.

7. A game enhancement queuing method for a gaming system including game-logic circuitry, the method comprising the game-logic circuitry implementing the following steps:
directing one or more electronic display devices to display a First-In-First-Out (FIFO) queue having an entry position, an exit position, and one or more intermediate positions between the entry and exit positions;
selecting a game enhancement from a plurality of available game enhancements, each of the plurality being associated with a respective enhancement identifier;
directing one or more electronic display devices to shift any enhancement identifiers in the FIFO queue from the entry position towards the exit position with the enhancement identifier associated with the selected game enhancement entering the FIFO queue at the entry position and any enhancement identifier at the exit position leaving the FIFO queue;
randomly generating a game outcome and applying all the game enhancements associated with enhancement identifiers in the FIFO queue to the game outcome;
directing one or more electronic display devices to display a symbol array representing the game outcome with the applied game enhancements; and
repeating the directing, selecting, and randomly generating steps to present one or more subsequent symbol arrays.

8. The game enhancement queuing method of claim 7, wherein the steps further include:
directing one or more electronic display devices to display a procession of game enhancement icons and respective associated enhancement identifiers proceeding along a parade route; and
in response to selecting the game enhancement, diverting an enhancement icon associated with the selected game enhancement from the parade route to a reception area; and
wherein the enhancement icon associated with the selected game enhancement enters the FIFO queue from the reception area.

9. The game enhancement queuing method of claim 7, wherein the selected game enhancement of the plurality includes multiple sub-attributes, and wherein selecting the game enhancement includes selecting one of the multiple sub-attributes.

10. The game enhancement queuing method of claim 7, wherein the selected game enhancement of the plurality includes multiple sub-attributes, and wherein a sub-attribute of the selected game enhancement is randomly selected separately from the game enhancement.

11. A game enhancement queuing method for a game sequence, the method comprising:
providing, via game-logic circuitry, a data structure establishing a logical First-In-First-Out (FIFO) queue having an entry position, an exit position, and one or more intermediate positions between the entry and exit positions;
displaying, on at least one electronic display device via direction of the game-logic circuitry, a visual representation of the logical FIFO queue including one or more game enhancement identifiers, each of the one or more enhancement identifiers being associated with a respective game enhancement assigned to a particular logical FIFO queue position;
selecting, via game-logic circuitry, a game enhancement from a plurality of available game enhancements and assigning the selected game enhancement to the entry position of the logical FIFO queue, any game enhancements in the logical FIFO shifting from the entry position towards the exit position;
shifting, on an electronic display device via direction of the game-logic circuitry, any enhancement identifiers in the displayed FIFO queue from the entry position towards the exit position with the enhancement identifier for the selected game enhancement entering the displayed FIFO queue at the entry position and any enhancement identifier at the exit position leaving the displayed FIFO queue;
randomly generating a game outcome and applying all game enhancements assigned to positions in the logical FIFO queue to the game outcome;
displaying, on at least one electronic display device via direction of the game-logic circuitry, a symbol array representing the game outcome with the applied game enhancements; and
repeating the selecting, shifting, and randomly generating steps to present a subsequent symbol array.

12. The game enhancement queuing method of claim 11, further comprising, in response to detecting a wager of a first amount, directing, via the game-logic circuitry, an electronic display device to populate the FIFO queue with enhancement identifiers that were in the FIFO queue after a previous wager of the first amount.

13. The game enhancement queuing method of claim 11, wherein one or more of the game enhancements change symbols available for display in a symbol array.

14. The game enhancement queuing method of claim 11, wherein one or more of the game enhancements alter a paytable applied to the game outcome.

15. The game enhancement queuing method of claim 11, further comprising:
displaying, on an electronic display device via direction of the game-logic circuitry, a procession of game enhancement icons with associated enhancement identifiers, the procession of enhancement icons proceeding around a parade route;
in response to selecting the game enhancement, diverting an enhancement icon of the procession associated with an enhancement identifier corresponding to the selected game enhancement from the parade route to a reception area; and
entering the enhancement identifier of the icon in the reception area at the entry position of the displayed FIFO queue.

16. The game enhancement queuing method of claim 15, wherein the reception area is displayed proximal to a symbol array that varies to display symbols representing the game outcome.

17. The game enhancement queuing method of claim 15, wherein the procession of enhancement icons includes a fixed number of enhancement icons that proceed around the parade route in a fixed order.

18. The game enhancement queuing method of claim 17, wherein the respective enhancement identifiers associated with the each of the plurality of enhancement icons are unchanging.

19. A gaming system configured to present distinctive, successive, enhanced symbol games over successive game instances, the gaming system comprising:
one or more electronic display devices;
game-logic circuitry configured to present a symbol array by:
directing at least one of the one or more electronic display devices to display a parade route populated by a procession of game enhancement icons, each enhancement icon having game enhancement identifier a corresponding with one of a plurality of available game enhancements;
randomly selecting a game enhancement from the plurality;
in response to selecting the game enhancement, directing one of the one or more electronic display devices to divert one the procession of enhancement icons from the parade route to a reception area, the diverted one having the enhancement identifier corresponding to the selected game enhancement;
directing at least one of the one or more electronic display devices to display the enhancement identifier corresponding to the selected game enhancement at an entry position of a First-In-First-Out (FIFO) queue and to shift any other game enhancements in the FIFO queue towards an exit position;
directing at least one of the one or more display devices to display the first symbol array with the first game enhancement applied thereto; and
the game-logic circuitry further configured to repeat the preceding steps to present subsequent symbol array.

20. The gaming system of claim 19, wherein the selected game enhancement includes multiple sub-attributes, and wherein selecting the game enhancement includes selecting one of the multiple sub-attributes.
